(19) United States
(12) Patent Application Publication
(10) Pub. No.: US 2009/0008246 A1
(43) Pub. Date: Jan. 8, 2009

(54) Cartridge for Containing and Dispensing Test Sensors

(76) Inventors: Jeffrey S. Reynolds, Granger, IN (US); Shu Kun Chang, Evanston, IL (US); Benjamin Rush, Evanston, IL (US)

Correspondence Address: NIXON PEABODY LLP, 161 N. CLARK STREET, 48TH FLOOR, CHICAGO, IL, 60601, US

(21) Appl. No.: 11/664,973

(22) PCT Filed: Oct. 19, 2005
(86) PCT No.: PCT/US05/37355

§ 371 Date: Apr. 9, 2007

Related U.S. Application Data
(60) Provisional application No. 60/620,710, filed on Oct. 20, 2004.

(51) Int. Cl. G01N 27/26; B01J 19/00; G07F 11/00

(52) U.S. Cl. 204/400; 422/68.1; 221/1

(57) ABSTRACT

A cartridge comprises a plurality of test sensors, a housing and a window. The plurality of test sensors is adapted to be used in determining the concentration of an analyte of a fluid sample. The plurality of test sensors is in a stacked position. The housing includes an interior, at one least wall and a sensor-discharge opening. The housing is adapted to contain the plurality of test sensors within the interior of the housing. The window is disposed within the at least one wall of the housing. The window permits a user of the cartridge to visually determine the number of test sensors remaining within the interior of the housing. The cartridge is adapted to dispense the plurality of test sensors one at a time from the sensor-dispensing opening.

### FIELD OF THE INVENTION

The present invention relates generally to test sensors for use in determining an analyte in a fluid sample and, more particularly, to a cartridge for containing and dispensing a plurality of test sensors.

### BACKGROUND OF THE INVENTION

It is often necessary to quickly obtain a fluid sample (e.g., blood) and to determine an analyte concentration (e.g., glucose) of the sample. One example of a need for obtaining a blood sample is in connection with a blood-glucose monitoring system, which a user must frequently use to monitor the user's blood glucose level. Because users must frequently self-test, manufacturers of blood-glucose monitoring systems are continually striving to simplify the testing process for the user.

One method of obtaining a blood sample and analyzing the sample for determining the glucose level is with a lancing device and a blood-collection device. In obtaining a blood sample, a drop of blood is obtained from, for example, the fingertip using the lancing device, and the blood is harvested using a test sensor. The blood is then analyzed by an instrument or meter to determine the glucose concentration in the blood by using an electrochemical- or optical-based analysis. Electrochemical-based test sensors include a reagent designed to react with glucose in the blood to create an oxidation current at electrodes disposed within the electrochemical biosensor that is directly proportional to the user's blood-glucose concentration. Optional-based test sensors incorporate a reagent designed to produce a colorimetric reaction indicative of a user's blood-glucose concentration level, which is then read by a spectrometer incorporated in the instrument.

These test sensors may be stored in cartridges that dispense the test sensors one at a time. One disadvantage of such cartridges is the ability of a user to determine how many test sensors remain in the cartridge. It would be desirable to have a cartridge that is easy for the user to use, while still being able to determine the number of test sensors remaining.

### SUMMARY OF THE INVENTION

According to one embodiment, a cartridge comprises a plurality of test sensors, a housing and a window. The plurality of test sensors is adapted to be used in determining the concentration of an analyte of a fluid sample. The plurality of test sensors is in a stacked position. The housing includes an interior, at one least wall and a sensor-discharge opening. The housing is adapted to contain the plurality of test sensors within the interior of the housing. The window is disposed within the at least one wall of the housing. The window permits a user of the cartridge to visually determine the number of test sensors remaining within the interior of the housing. The cartridge is adapted to dispense the plurality of test sensors one at a time from the sensor-dispensing opening.

According to another embodiment, a cartridge comprises a plurality of test sensors, a housing and a window. The plurality of test sensors is adapted to be used in determining the concentration of an analyte of a fluid sample. The plurality of test sensors is in a stacked position. Each of the plurality of test sensors includes a fluid receiving-area. The fluid-receiving area includes reagent. The housing includes an interior, at least one wall, and a sensor-discharge opening. The housing is adapted to contain the plurality of test sensors within the interior of the housing. The window is disposed within the at least one wall of the housing and is located to minimize the exposure of the reagent. The window permits a user of the cartridge to visually determine the number of test sensors remaining within the interior of the housing. The cartridge is adapted to dispense the plurality of test sensors one at a time.

According to one method, a cartridge is provided that contains a plurality of test sensors, a housing and a window. The plurality of test sensors is adapted to be used in determining the analyte of a fluid sample. The plurality of test sensors is in a stacked position. The housing includes an interior, at one least wall and a sensor-discharge opening. The housing is adapted to contain the plurality of test sensors within the interior of the housing. The window is disposed within the at least one wall of the housing. The number of test sensors remaining within the interior of the housing is visually determined via the window.

### BRIEF DESCRIPTION OF THE DRAWINGS

FIG. 1a is a side view of a test-sensor cartridge with portions thereof removed to show the cartridge interior according to one embodiment of the present invention.

FIG. 1b is a test sensor including a lid according to one embodiments.

FIG. 1c is the test sensor of FIG. 1b without the lid.

FIG. 2a is a side view of a test-sensor cartridge with a seal in a closed position according to one embodiment of the present invention.

FIG. 2b is a side view of the test-sensor cartridge of FIG. 2a with the seal in the open position having a test sensor extending therethrough.

FIG. 3 is a perspective view of a test-sensor cartridge according to one embodiment of the present invention.

FIG. 4 is a side view of a side wall of a test-sensor cartridge according to another embodiment of the present invention.

FIG. 5 is a side view of a side wall of a test-sensor cartridge according to a further embodiment of the present invention.

FIG. 6 is a side view of a side wall of a test-sensor cartridge according to yet another embodiment of the present invention.

While the invention is susceptible to various modifications and alternative forms, specific embodiments are shown by way of example in the drawings and are described in detail herein. It should be understood, however, that the invention is not intended to be limited to the particular forms disclosed. Rather, the invention is to cover all modifications, equivalents, and alternatives falling within the spirit and scope of the invention.

### DETAILED DESCRIPTION OF THE ILLUSTRATED EMBODIMENTS

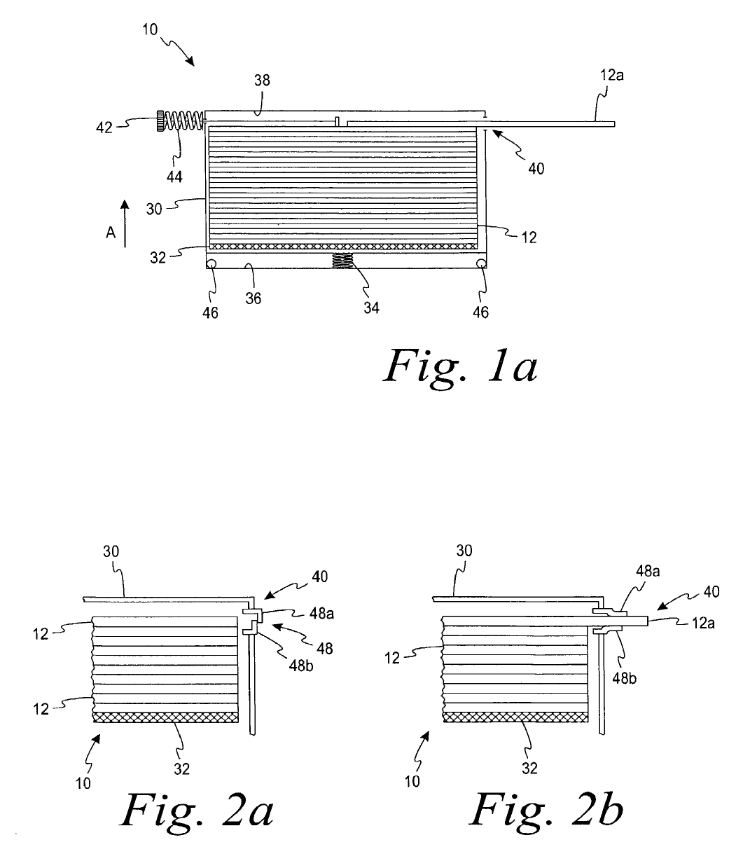

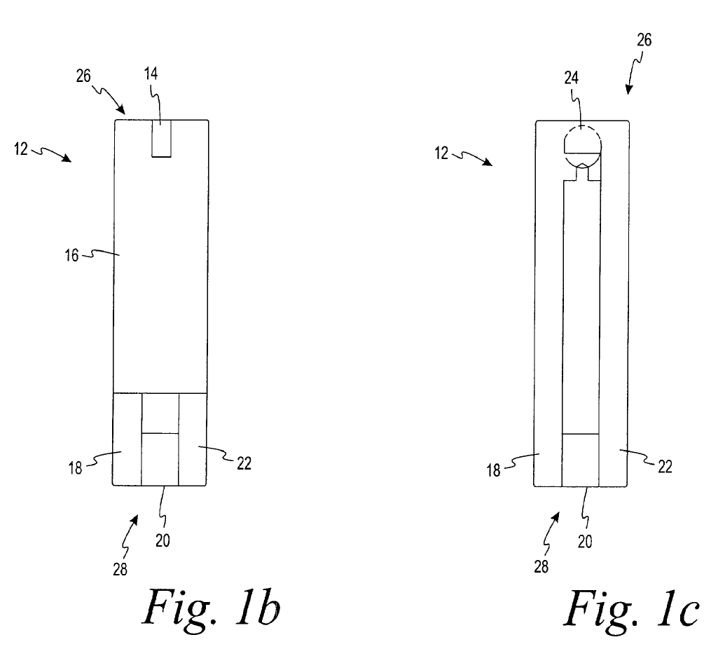

Turning to the drawings, and initially to FIG. 1a, a cartridge 10 for containing and dispensing a plurality of test sensors 12 is shown according to one embodiment of the present invention. The cartridge may be adapted to be placed with a sensor-dispensing instrument that assists in determining the analyte concentration. In such an embodiment, the cartridge 10 is typically removed from the sensor-dispensing instrument (and disposed of) once all the test sensors 12 are used. A second cartridge with an unused plurality of test sensors then replaces the spent cartridge 10 within the instrument.

Generally, a test sensor 12 is dispensed from the cartridge 10, one at a time, on an as-needed basis for use in determining an analyte concentration of a sample. The plurality of test sensors 12 may be electrochemical- or optical-based.

According to one embodiment, one of the test sensors 12 is depicted in FIGS. 1b, 1c. FIGS. 1b, 1c depict a test sensor 12 that includes a capillary channel 14, a lid 16, and a plurality of electrodes 18, 20, 22. The plurality of electrodes includes a counter electrode 18, a detection electrode 20, and a working (measuring) electrode 22. As shown in FIG. 1c, the test sensor 12 includes a fluid-receiving area 24 that contains reagent. The operation of the fluid-receiving area 24 with reagent and the electrodes on the test sensor is known to those skilled in the art and will therefore not be described in further detail. Examples of electrochemical test sensors, including their operation, may be found at, for example, U.S. patent application published as 2001/0042683 and EP 1152239. It is contemplated that other electrochemical test sensors may be employed. Examples of optical test sensors are described in U.S. Pat. No. 5,194,393. It is contemplated that other examples of optical test sensors may be used.

The plurality of test sensors 12 is used in determining the analyte concentration in a fluid sample. For example, glucose in a whole blood sample may be determined. In other embodiments, the plurality of test sensors 12 may be used for determining the concentration or presence of other analytes. Some analytes include glucose, lipid profiles (e.g., cholesterol, triglycerides, LDL and HDL), microalbumin, hemoglobin A₁C, fructose, lactate, or bilirubin. The present invention is not limited, however, to determining these specific analytes and it is contemplated that other analyte concentrations may be determined. The analytes may be in, for example, a whole blood sample, a blood serum sample, a blood plasma sample, or other body fluids like ISF (interstitial fluid) and urine.

The cartridge 10 comprises a housing 30 in which the plurality of test sensors 12 is stacked on a platform 32 therein. The platform 32 is upwardly biased (as viewed in the direction of arrow A in FIG. 1a) with a resilient member such as a spring 34 disposed between an interior bottom surface 36 of the housing 30 and the platform 32. The upwardly-biased platform 32 urges the stack of test sensors 12 towards an interior top surface 38 of the housing so as to align an uppermost test sensor 12a with a sensor-discharge opening or slot 40 of the housing 30. To better illustrate the platform 32 in the figures, the platform 32 is cross-hatched to better distinguish the platform 32 from the plurality of test sensors 12 stacked thereon.

To dispense a test sensor 12 from the cartridge 10, a plunger 42 is depressed according to one embodiment. The plunger 42 forces the uppermost test sensor 12a toward the opening 40 as shown in FIG. 1a. After a test sensor 12 is dispensed, a spring 44 moves the plunger 42 to its home position (not shown, to the left as viewed in FIG. 1a) to permit the spring 44 to urge the platform 32, and in turn the stack of test sensors 12 upward. At this point, depressing the plunger 42 dispenses a new test sensor 12.

In alternative embodiments of the present invention, other mechanisms may be used for dispensing the test sensors 12 from the cartridge 10. For example, a slide mechanism disposed along the top of the cartridge, when advanced, may be used to engage and dispense the uppermost test sensor.

The plurality of test sensors 12 of FIG. 1a is in communication with a desiccant material 46 disposed within the cartridge 10. The desiccant material 46 maintains the interior of the cartridge 10 at an appropriate humidity level so that any reagent material disposed within the test sensors 12 is not adversely affected prior to being used. The desiccant material 46 may be in the form of a small bag, round bead of material, a hot melt, a molded shape or any other form that can be in communication with the plurality of test sensors 12.

While the desiccant material 46 shown in FIG. 1 is disposed towards the bottom of the cartridge 10, the desiccant material may be disposed anywhere practical within the cartridge. The amount of desiccant material 46 placed within the cartridge 10 is dependent on the amount that is required to maintain the interior of the cartridge 10 in a desiccated state. One type of commercially available desiccant material that can be used in the cartridge is 13× synthetic molecular sieves from Multisorb Technologies Inc. of Buffalo, N.Y., that is available in powder, pellet, and bead forms.

Referring also to FIGS. 2a and 2b, the cartridge 10 includes a seal 48 having a lower member 48a and an upper member 48b. The upper and lower members 48a, 48b may be constructed of a resilient, moisture impervious material such as rubber, which allows a test sensor 12 to be dispensed through the seal 48 as illustrated. The seal 48 aids in preventing or inhibiting moisture from entering the cartridge 10, which may adversely affect the reagent within the test sensors 12. Similarly, the interface between the plunger 42 of FIG. 1a and the housing 30 may also be sealed. Seals of other types than the illustrated seal 48 may be used in alternative embodiments of the present invention.

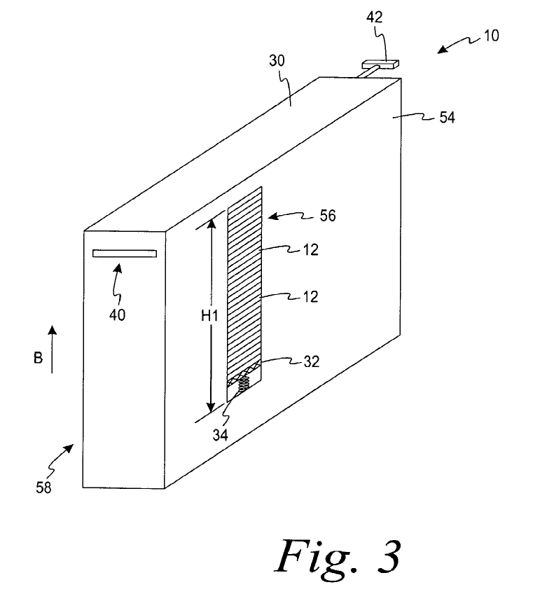

Referring now to FIG. 3, the cartridge 10 is shown according to one embodiment of the present invention. The housing 30 of the cartridge 10 includes a side wall 54 that forms a window 56, and an opposing side wall 58. In the illustrated embodiment, the window 56 is disposed generally parallel to the direction in which the platform 32 urges the stack of test sensors 12. In other words, a longitudinal axis or height H1 of the window 56 is generally parallel to the direction in which the stacked test sensors 12 are urged (direction of arrow B in FIG. 3).

The window 56 is constructed of a material sufficiently optically clear to permit a user on visual inspection to discern the stack of test sensors 12 disposed within the cartridge 10. The window 56 generally permits the user to quickly determine how many test sensors 12 remain within the cartridge 10. In alternative embodiments of the present invention, the window 56 may be placed on one or more sides of the cartridge 10 to provide a user with even greater visual access in determining the number of remaining test sensors 12.

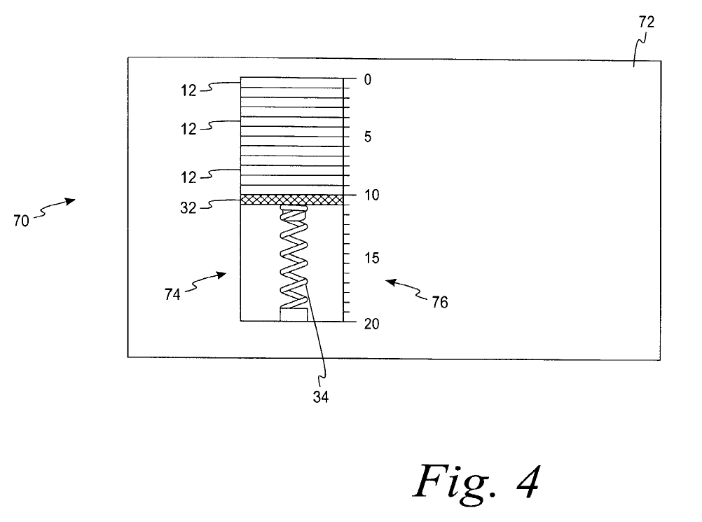

According to another embodiment, a cartridge 70 of FIG. 4 includes a side wall 72 that forms a window 74. The side wall 72 includes a numerical scale 76 adjacent to the window 74. The position of the platform 32 relative to the numerical scale 76 informs a user of the number of test sensors 12 remaining within the cartridge 70. The numerical scale 76 includes twenty positions (i.e., 20-0) for indicting that twenty or fewer test sensors 12 remain within the cartridge 70. It is contemplated that the numerical scale may include more positions than shown in FIG. 4. In the illustrated embodiment, the platform 32 is aligned with the number “10” of the scale 76, which indicates that ten test sensors 12 remain within the cartridge 70. In alternative embodiments of the present invention, the platform 32 may be colored different than the test sensors 12 to permit a user to more easily perceive the platform 32 on visual inspection of the cartridge 70 for determining the number of test sensors 12 remaining. For example, the platform 32 may be brightly colored (e.g., red, yellow, orange, etc.), which permits it to be readily perceived by a user of the cartridge 70.

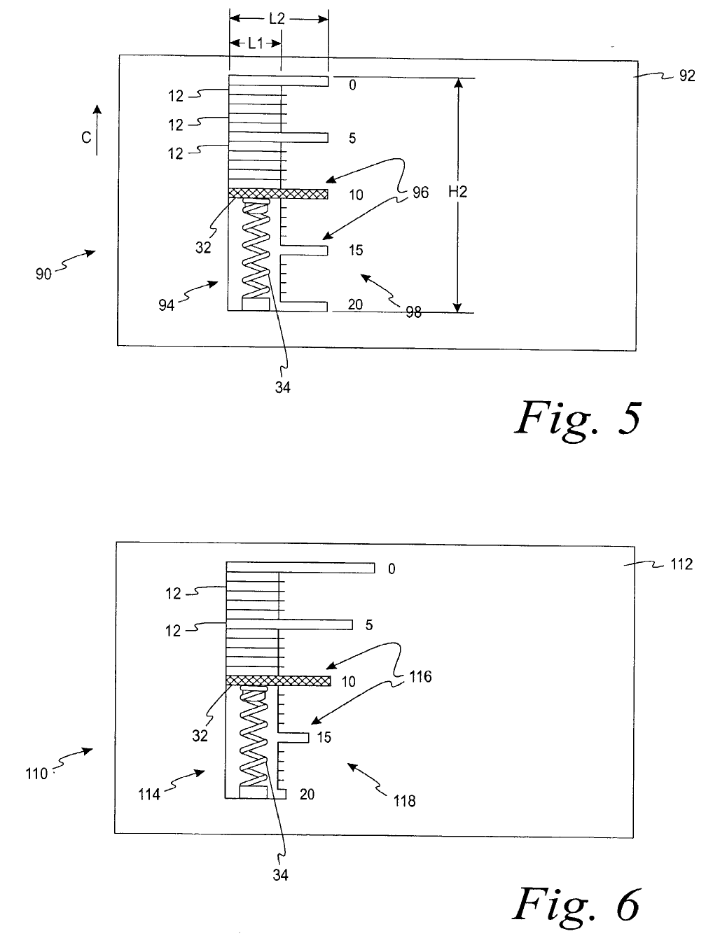

FIG. 5 illustrates a cartridge 90 that includes a side wall 92 that forms a window 94. The window 94 includes a plurality of strip-count windows 96 outwardly extending from the window 94, which correspond to major numbers (e.g., 0, 5, 10, 15, and 20) on an adjacent numerical scale 98. As shown in FIG. 5, the strip-count windows 96 have a length L2, which is greater than the remainder of the window 94 that has a length L1. The window 94 has a longitudinal axis or height H2 that is generally parallel with the direction in which the platform urges the stack of test sensors 12 (direction of arrow C in FIG. 5). The frequency of the strip-count windows 96 may be varied in alternative embodiments of the present invention. In the illustrated embodiment, the strip-count windows 96 are positioned five intervals apart on the numerical scale 98. Each strip-count window 96 provides an increased viewing area that permits the platform 32 to be more readily viewable to the user of the cartridge 90. The strip-count windows 96 may vary in length and height in alternative embodiments of the present invention. In the illustrated embodiment, the strip-count windows 96 are disposed generally perpendicular to the direction in which the platform 32 urges the stack of test sensors 12 (direction of arrow C in FIG. 5). For example, in one embodiment of the present invention, each strip-count window 96 has a height corresponding to the thickness of the platform 32.

FIG. 6 illustrates yet a further embodiment of a cartridge (cartridge 110). The cartridge 110 includes a side wall 112 that forms a window 114. Similar to that illustrated in FIG. 5, the window 114 of FIG. 6 includes a plurality of strip-count windows 116 that correspond to major numbers on an adjacent numerical scale 118. The strip-count windows 116 are graduated with each strip-count window 116 increasing in length as numbers on the numerical scale 118 decreases. In alternative embodiments, each strip-count window may be graduated such that each strip-count window decreases in length as numbers on the numerical scale decrease.

To limit the exposure of the test sensors 12, and specifically the reagent contained therein, to harmful light, the windows discussed above may be constructed of different materials. For example, the windows may be made of a translucent material, optical clear material, a colored material, or combinations thereof. For example, a window may be constructed of a yellow polymeric material that limits the test sensor's exposure to harmful radiation from high-energy blue light or ultraviolet light. It is contemplated that the windows may be made of polymeric materials such as acrylic or polycarbonate.

The window may include pigments that change color to block higher-energy energy light from reaching and affecting the reagent, if any, in the plurality of test sensors 12. It is desirable for the window to be positioned away from the reagent so as to minimize the exposure of the reagent to harmful light.

In addition to the above-described optical qualities, the windows may be sealed (e.g., hermetically sealed) to the housing to prevent or inhibit the introduction of moisture into the cartridge. Further, the window may be constructed of a material that provides a sufficient barrier to moisture. Such materials include, for example, glass and polymeric materials.

The window may be positioned away from the portion of the test sensors that contains the reagent. For example, referring back to FIGS. 1b, 1c, the fluid-receiving area 24 with reagent is disposed toward a front end 26 of the test sensor 12. Referring to FIG. 3, the front end 26 of the test sensor 12 may be located nearest the side wall 58, while the back end 26 of the test sensor 12 is located nearest the sidewall 54 in which the window 56 is formed therein. Alternatively, the window may be offset from the reagent portion of the test sensor such that the reagent portion does not receive direct light exposure.

### Embodiment A

A cartridge comprising:

a plurality of test sensors being adapted to be used in determining the concentration of an analyte of a fluid sample, the plurality of test sensors being in a stacked position;

a housing including an interior, at one least wall and a sensor-discharge opening, the housing being adapted to contain the plurality of test sensors within the interior of the housing; and

a window being disposed within the at least one wall of the housing, the window permitting a user of the cartridge to visually determine the number of test sensors remaining within the interior of the housing,

wherein the cartridge is adapted to dispense the plurality of test sensors one at a time from the sensor-dispensing opening.

### Embodiment B

The cartridge of embodiment A wherein the plurality of test sensors is electrochemical test sensors.

### Embodiment C

The cartridge of embodiment A wherein the housing is sealed so as to inhibit introducing moisture into the interior of the housing.

### Embodiment D

The cartridge of embodiment C wherein the housing includes a first seal and a second seal that are adapted to move between a closed position and an open position and wherein the open position of the first and second seals allows a test sensor to exit the cartridge.

### Embodiment E

The cartridge of embodiment A further comprising a desiccant material disposed within the housing.

### Embodiment F

The cartridge of embodiment A further comprising a numerical scale on the at least one wall, the numerical scale being disposed adjacent to the window.

### Embodiment G

The cartridge of embodiment F further comprising a platform disposed in the interior of the housing on which the plurality of test sensors is stacked, wherein the position of the platform relative to the numerical scale indicates the number of test sensors remaining within the interior of the housing.

### Embodiment H

The cartridge of embodiment G wherein the platform is biased to urge the plurality of test sensors stacked thereon in a first direction and wherein a longitudinal axis of the window is generally parallel to the first direction.

### Embodiment I

The cartridge of embodiment G wherein the platform is a first color and the plurality of test sensors is a second color.

### Embodiment J

The cartridge of embodiment A wherein the window includes a plurality of strip-count windows.

### Embodiment K

The cartridge of embodiment J further comprising a platform disposed in the interior of the housing on which the plurality of test sensors is stacked, wherein the platform is biased to urge the plurality of test sensors stacked thereon in a first direction and the plurality of strip-count windows being formed in a second direction that is generally perpendicular to the first direction.

### Embodiment L

The cartridge of embodiment K wherein the plurality of strip-count windows has at least two different lengths.

### Embodiment M

The cartridge of embodiment K wherein the heights of the plurality of test sensors are the same as the height of the platform.

### Embodiment N

The cartridge of embodiment A wherein the window is constructed of a colored material.

### Embodiment O

The cartridge of embodiment A wherein the window is constructed of a translucent material.

### Embodiment P

The cartridge of embodiment A wherein the analyte comprises glucose and the fluid sample comprises blood.

### Embodiment Q

A cartridge comprising:

a plurality of test sensors being adapted to be used in determining the concentration of an analyte of a fluid sample, the plurality of test sensors being in a stacked position, each of the plurality of test sensors including a fluid receiving-area, the fluid-receiving area including reagent;

a housing including an interior, at least one wall, and a sensor-discharge opening, the housing being adapted to contain the plurality of test sensors within the interior of the housing; and

a window being disposed within the at least one wall of the housing and being located to minimize the exposure of the reagent, the window permitting a user of the cartridge to visually determine the number of test sensors remaining within the interior of the housing,

wherein the cartridge is adapted to dispense the plurality of test sensors one at a time.

### Embodiment R

The cartridge of embodiment Q wherein the plurality of test sensors is electrochemical test sensors.

### Embodiment S

The cartridge of embodiment Q wherein the housing is sealed so as to inhibit introducing moisture into the interior of the housing.

### Embodiment T

The cartridge of embodiment S wherein the housing includes a first seal and a second seal that are adapted to move between a closed position and an open position and wherein the open position of the first and second seals allows a test sensor to exit the cartridge.

### Embodiment U

The cartridge of embodiment Q further comprising a desiccant material disposed within the housing.

### Embodiment V

The cartridge of embodiment Q further comprising a numerical scale on the at least one wall, the numerical scale being disposed adjacent to the window.

### Embodiment W

The cartridge of embodiment V further comprising a platform disposed in the interior of the housing on which the plurality of test sensors is stacked, wherein the position of the platform relative to the numerical scale indicates the number of test sensors remaining within the interior of the housing.

### Embodiment X

The cartridge of embodiment W wherein the platform is biased to urge the plurality of test sensors stacked thereon in a first direction and wherein a longitudinal axis of the window is generally parallel to the first direction.

### Embodiment Y

The cartridge of embodiment W wherein the platform is a first color and the plurality of test sensors is a second color.

### Embodiment Z

The cartridge of embodiment Q wherein the window includes a plurality of strip-count windows.

### Embodiment AA

The cartridge of embodiment Z further comprising a platform disposed in the interior of the housing on which the plurality of test sensors is stacked, wherein the platform is biased to urge the plurality of test sensors stacked thereon in a first direction and the plurality of strip-count windows being formed in a second direction that is generally perpendicular to the first direction.

### Embodiment BB

The cartridge of embodiment Z wherein the plurality of strip-count windows has at least two different lengths.

### Embodiment CC

The cartridge of embodiment Z wherein the heights of the plurality of test sensors are the same as the height of the platform.

### Embodiment DD

The cartridge of embodiment Q wherein the window is constructed of a colored material.

### Embodiment EE

The cartridge of embodiment Q wherein the window is constructed of a translucent material.

### Embodiment FF

The cartridge of embodiment Q wherein the analyte comprises glucose and the fluid sample comprises blood.

### Embodiment GG

The cartridge of embodiment Q wherein the window is located opposite of the fluid-receiving area that includes reagent.

### Embodiment HH

The cartridge of embodiment Q wherein the window is offset from the fluid-receiving area that includes reagent.

### Embodiment II

A method of using a cartridge comprising the acts of:

providing a cartridge containing a plurality of test sensors, a housing and a window, the plurality of test sensors being adapted to be used in determining the analyte of a fluid sample, the plurality of test sensors being in a stacked position, the housing including an interior, at one least wall and a sensor-discharge opening, the housing being adapted to contain the plurality of test sensors within the interior of the housing, the window being disposed within the at least one wall of the housing; and

visually determining the number of test sensors remaining within the interior of the housing via the window.

### Embodiment JJ

The method of embodiment II further comprising dispensing one of the plurality of test sensors from the cartridge via the sensor-discharge opening.

### Embodiment KK

The method of embodiment II wherein determining includes comparing the viewed test sensors to a numerical scale disposed on the cartridge.

### Embodiment LL

The method of embodiment II wherein each of the plurality of test sensors includes a fluid receiving-area, the fluid-receiving area including reagent and wherein the window is located to minimize the exposure of the reagent.

### Embodiment MM

The method of embodiment LL wherein the window is located opposite of the fluid-receiving area that includes reagent.

### Embodiment NN

The method of embodiment LL wherein the window is offset from the fluid-receiving area that includes reagent.

### Embodiment OO

The method of embodiment II wherein the cartridge further comprises a numerical scale on the at least one wall, the numerical scale being disposed adjacent to the window.

### Embodiment PP

The method of embodiment OO wherein the cartridge further comprises a platform disposed in the interior of the housing on which the plurality of test sensors is stacked, wherein the position of the platform relative to the numerical scale indicates the number of test sensors remaining within the interior of the housing.

### Embodiment QQ

The method of embodiment PP wherein the platform is biased to urge the plurality of test sensors stacked thereon in a first direction and wherein a longitudinal axis of the window is generally parallel to the first direction.

### Embodiment RR

The method of embodiment PP wherein the platform is a first color and the plurality of test sensors is a second color.

### Embodiment SS

The method of embodiment II wherein the window includes a plurality of strip-count windows.

### Embodiment TT

The method of embodiment SS wherein the cartridge further comprises a platform disposed in the interior of the housing on which the plurality of test sensors is stacked, wherein the platform is biased to urge the plurality of test sensors stacked thereon in a first direction and the plurality of strip-count windows being formed in a second direction that is generally perpendicular to the first direction.

### Embodiment UU

The method of embodiment TT wherein the plurality of strip-count windows has at least two different lengths.

### Embodiment VV

The method of embodiment II wherein the heights of the plurality of test sensors are the same as the height of the platform.

### Embodiment WW

The method of embodiment II wherein the window is constructed of a colored material.

### Embodiment XX

The method of embodiment II wherein the window is constructed of a translucent material.

### Embodiment YY

The method of embodiment II wherein the analyte comprises glucose and the fluid sample comprises blood.

While the invention is susceptible to various modifications and alternative forms, specific embodiments thereof have been shown by way of example in the drawings and are described in detail herein. It should be understood, however, that it is not intended to limit the invention to the particular forms disclosed, but, to the contrary, the intention is to cover all modifications, equivalents and alternatives falling within the spirit and scope of the invention.

1. A cartridge comprising:
a plurality of test sensors being adapted to be used in determining the concentration of an analyte of a fluid sample, the plurality of test sensors being in a stacked position;
a housing including an interior, at one least wall and a sensor-discharge opening, the housing being adapted to contain the plurality of test sensors within the interior of the housing; and
a window being disposed within the at least one wall of the housing, the window permitting a user of the cartridge to visually determine the number of test sensors remaining within the interior of the housing,
wherein the cartridge is adapted to dispense the plurality of test sensors one at a time from the sensor-dispensing opening.

2. The cartridge of claim 1, wherein the plurality of test sensors is electrochemical test sensors.

3. (canceled)

4. (canceled)

5. (canceled)

6. The cartridge of claim 1, further comprising a numerical scale on the at least one wall, the numerical scale being disposed adjacent to the window.

7. The cartridge of claim 6, further comprising a platform disposed in the interior of the housing on which the plurality of test sensors is stacked, wherein the position of the platform relative to the numerical scale indicates the number of test sensors remaining within the interior of the housing.

8. (canceled)

9. The cartridge of claim 7, wherein the platform is a first color and the plurality of test sensors is a second color.

10. The cartridge of claim 1, wherein the window includes a plurality of strip-count windows.

11. The cartridge of claim 10, further comprising a platform disposed in the interior of the housing on which the plurality of test sensors is stacked, wherein the platform is biased to urge the plurality of test sensors stacked thereon in a first direction and the plurality of strip-count windows being formed in a second direction that is generally perpendicular to the first direction.

12. The cartridge of claim 11, wherein the plurality of strip-count windows has at least two different lengths.

13. The cartridge of claim 11, wherein the heights of the plurality of test sensors are the same as the height of the platform.

14. (canceled)

15. (canceled)

16. (canceled)

17. A cartridge comprising:
a plurality of test sensors being adapted to be used in determining the concentration of an analyte of a fluid sample, the plurality of test sensors being in a stacked position, each of the plurality of test sensors including a fluid receiving-area, the fluid-receiving area including reagent;
a housing including an interior, at least one wall, and a sensor-discharge opening, the housing being adapted to contain the plurality of test sensors within the interior of the housing; and
a window being disposed within the at least one wall of the housing and being located to minimize the exposure of the reagent, the window permitting a user of the cartridge to visually determine the number of test sensors remaining within the interior of the housing,
wherein the cartridge is adapted to dispense the plurality of test sensors one at a time.

18. The cartridge of claim 17, wherein the plurality of test sensors is electrochemical test sensors.

19. (canceled)

20. (canceled)

21. (canceled)

22. The cartridge of claim 17, further comprising a numerical scale on the at least one wall, the numerical scale being disposed adjacent to the window.

23. The cartridge of claim 22, further comprising a platform disposed in the interior of the housing on which the plurality of test sensors is stacked, wherein the position of the platform relative to the numerical scale indicates the number of test sensors remaining within the interior of the housing.

24. (canceled)

25. The cartridge of claim 23, wherein the platform is a first color and the plurality of test sensors is a second color.

26. The cartridge of claim 17, wherein the window includes a plurality of strip-count windows.

27. The cartridge of claim 26, further comprising a platform disposed in the interior of the housing on which the plurality of test sensors is stacked, wherein the platform is biased to urge the plurality of test sensors stacked thereon in a first direction and the plurality of strip-count windows being formed in a second direction that is generally perpendicular to the first direction.

28. The cartridge of claim 26, wherein the plurality of strip-count windows has at least two different lengths.

29. The cartridge of claim 26, wherein the heights of the plurality of test sensors are the same as the height of the platform.

30. (canceled)

31. (canceled)

32. (canceled)

33. The cartridge of claim 17, wherein the window is located opposite of the fluid-receiving area that includes reagent.

34. The cartridge of claim 17, wherein the window is offset from the fluid-receiving area that includes reagent.

35. A method of using a cartridge comprising the acts of:
providing a cartridge containing a plurality of test sensors, a housing and a window, the plurality of test sensors being adapted to be used in determining the analyte of a fluid sample, the plurality of test sensors being in a stacked position, the housing including an interior, at one least wall and a sensor-discharge opening, the housing being adapted to contain the plurality of test sensors within the interior of the housing, the window being disposed within the at least one wall of the housing; and
visually determining the number of test sensors remaining within the interior of the housing via the window.

36. (canceled)

37. The method of claim 35, wherein determining includes comparing the viewed test sensors to a numerical scale disposed on the cartridge.

38. The method of claim 35, wherein each of the plurality of test sensors includes a fluid receiving-area, the fluid-receiving area including reagent and wherein the window is located to minimize the exposure of the reagent.

39. The method of claim 38, wherein the window is located opposite of the fluid-receiving area that includes reagent.

40. The method of claim 38, wherein the window is offset from the fluid-receiving area that includes reagent.

41. The method of claim 35, wherein the cartridge further comprises a numerical scale on the at least one wall, the numerical scale being disposed adjacent to the window.

42. The method of claim 41, wherein the cartridge further comprises a platform disposed in the interior of the housing on which the plurality of test sensors is stacked, wherein the position of the platform relative to the numerical scale indicates the number of test sensors remaining within the interior of the housing.

43. (canceled)

44. The method of claim 42, wherein the platform is a first color and the plurality of test sensors is a second color.

45. The method of claim 35, wherein the window includes a plurality of strip-count windows.

46. The method of claim 45, wherein the cartridge further comprises a platform disposed in the interior of the housing on which the plurality of test sensors is stacked, wherein the platform is biased to urge the plurality of test sensors stacked thereon in a first direction and the plurality of strip-count windows being formed in a second direction that is generally perpendicular to the first direction.

47. The method of claim 46, wherein the plurality of strip-count windows has at least two different lengths.

48. The method of claim 35, wherein the heights of the plurality of test sensors are the same as the height of the platform.

49. (canceled)

50. (canceled)

51. The method of claim 35, wherein the analyte comprises glucose and the fluid sample comprises blood.
